(19) United States
(12) Patent Application Publication
(10) Pub. No.: US 2014/0272898 A1
(43) Pub. Date: Sep. 18, 2014

(54) SYSTEM AND METHOD OF PROVIDING COMPOUND ANSWERS TO SURVEY QUESTIONS

(71) Applicant: Vision Critical Communications Inc., (US)

(72) Inventors: Chris Ryan, Vancouver (CA); Brett Glover, Vancouver (CA); Jason Roett, Abbotsford (CA)

(73) Assignee: VISION CRITICAL COMMUNICATIONS INC., Vancouver (CA)

(21) Appl. No.: 13/837,772

(22) Filed: Mar. 15, 2013

(51) Int. Cl. G06Q 30/02

(52) U.S. Cl. CPC G06Q 30/0243
USPC 434/353

(57) ABSTRACT

Embodiments disclosed herein include systems and methods which allow for the creation of online surveys in which answers to compound questions may be efficiently gather from online survey respondents using a space-efficient user interface configuration. The space-efficient user interface configuration reduces the perceived and/or actual time and effort needed to complete the survey, and allows the user to easily review previously submitted questions.

### BACKGROUND OF THE INVENTION

1. Field of the Invention

This application relates to the capture of response data from survey respondents in online surveys. In particular, the application relates to a system and method for presenting multiple related survey questions in such a way as to allow for quicker and easier responses from survey respondents and also allow for the capture of more detailed information from those respondents via a streamlined user interface.

2. Description of the Related Technology

Traditionally, surveys of public opinion were conducted over the telephone. A survey was typically conducted by a survey taker who presented a series of questions to survey participants and recorded the answers given to the questions. As computer technology evolved and the Internet became more ubiquitous in our daily lives, survey providers began developing software which allowed for surveys to be conducted online via web pages accessed through Internet browsing software. These online survey applications were typically designed to proceed in the same manner as telephonic surveys, with online users asked to answer questions presented sequentially, with the answers recorded by the survey software. Existing techniques for conducting online surveys are inadequate and suffer from various problems related to the way data is presented to and collected from survey participants. As a result, improved online survey systems and methods are needed.

### SUMMARY OF CERTAIN INVENTIVE ASPECTS

The system, method, and devices of the present invention each have several aspects, no single one of which is solely responsible for its desirable attributes. Without limiting the scope of this invention, several of its features will now be discussed briefly.

In one embodiment, a computer-implemented method of presenting and receiving compound answers to survey questions is provided. The method includes retrieving, from a computer memory, data indicative of a first question for which a user response is sought. The method further includes retrieving, from the computer memory, data indicative of a plurality of possible responses to the first question for which a user response is sought. Data indicative of a follow up question for each of the plurality of possible responses to the first question for which a user response is sought is also retrieved, as well as data indicative of a plurality of possible responses to each follow up question. A user interface element is generated for display on a user interface of a client device. The user interface element comprises at least a portion of a group of cells, and the at least a portion of the group of cells comprises rows and columns. Each row contains a cell indicative of a question subject and a plurality of cells arranged as table columns indicative of possible responses to the first question about the question subject. The method further includes receiving data indicative of an inputted selection of a first response from one of the possible responses, the inputted selection being a selection of the cell associated with the selected first response. Based on the data indicative of the inputted selection of a first response from one of the possible responses, the plurality of possible follow-up responses to the follow-up question for the selected first response are generated for display on the client device. Data indicative of an inputted selection of a follow-up response from one of the plurality of possible responses to the follow-up question is received, and based on the data indicative of the inputted selection of follow-up response, instructions for modifying the cell associated with the selected first response on the client device are generated. The modification of the cell provides an indication that the first question and the follow up question have been answered.

In another embodiment, an online survey system is provided. The system includes data storage configured to store data indicative of a first question for which a user response is sought, a plurality of possible responses to the first question for which a user response is sought, data indicative of a follow up question for each of the plurality of possible responses to the first question for which a user response is sought, and data indicative of a plurality of possible responses to each follow up question. The system further includes a computing device in communication with the data storage and configured to generate a for display on a user interface of a client device a user interface element, the user interface element comprising at least a portion of a group of cells, the at least a portion of the table group of cells comprising rows and columns, each row containing a cell indicative of a question subject and a plurality of cells arranged as columns indicative of possible responses to the first question about the question subject. The processor is further configured to receive data indicative of an inputted selection of a first response from one of the possible responses, the inputted selection being a selection of the cell associated with the selected first response, and based on the data indicative of the inputted selection of a first response from one of the possible responses, generate for display on the client device the plurality of possible follow-up responses to the follow-up question for the selected first response. The process also is configured to receive data indicative of an inputted selection of a follow-up response from one of the plurality of possible responses to the follow-up question; and based on the data indicative of the inputted selection of follow-up response, generate instructions configured to modify the cell associated with the selected first response on the client device. The modification of the cell provides an indication that the first question and the follow up question have been answered.

### BRIEF DESCRIPTION OF THE DRAWINGS

FIG. 1 is a top level diagram of a system for providing an online survey in accordance with one or more embodiments.

FIG. 2 is a block diagram providing a more detailed view of the survey module shown in FIG. 1.

FIG. 3A is a decision tree showing complex survey logic traditionally needed to capture user responses to initial question and follow-up response based on the answer to the initial question.

FIG. 3B is a modified decision tree illustrating how the complex survey logic from FIG. 3A may be simplified according to embodiments of the invention.

FIGS. 4A-4H are examples of a user interface which can capture user responses two separate but related questions as to related and conjoined selections in accordance with one or more embodiments.

FIG. 5 is a flowchart illustrating a process by which a survey may be defined in accordance with one or more embodiments.

FIG. 6 is a flowchart illustrating a process by which questions may be presented to survey respondents in accordance with one or more embodiments.

### DETAILED DESCRIPTION OF CERTAIN INVENTIVE EMBODIMENTS

The inventors have recognized that one of the challenges that online survey developers face is the need for a survey which does not require significant time or effort on the part of the user. If the survey respondent must repeatedly load new pages in order to complete the survey, it becomes more and more likely that the survey respondent will give up and not finish the survey. If the user fails to finish the survey, in many instances the data obtained is of dubious value. At the same time, online surveys should also be designed to collect as much detail from the survey respondent as is possible.

The need for simplicity in the interface has always been in tension with the desire for obtaining rich and meaningful data from survey respondents. Embodiments disclosed herein address this tension by providing systems and methods which allow for the creation and distribution of online surveys which allow for the collection of compound answers to survey questions. In particular, using the systems and methods disclosed herein, initial questions and answer-specific follow-up questions are presented in such a way as to reduce the perceived and/or actual time and effort needed to complete the survey. In some embodiments, the systems and methods disclosed herein generate a graphical user interface which presents two related questions which, separately, may be difficult to represent without redundancy and without taking up significant real estate on the user's display. The questions are consolidated and represented such that when the user response to the first question, the user is immediately presented with a menu of possible responses to a follow-up question based on the first answer given without the need for another page to load, or for significant changes to the graphical user interface. By reducing the perceived and/or actual time and effort needed to complete the survey, it is more likely that a given survey respondent will take the time to more accurately answer all of the survey questions, thereby yielding a more complete data set.

FIG. 1 is a block diagram of a computer system 100 for providing an online survey to survey respondents. The computer system 100 may generally take the form of computer hardware configured to execute certain processes and instructions in accordance with one or more embodiments described herein. The computer hardware may be a single computer or it may be multiple computers configured to work together. The computer system 100 includes a processor 102. The processor is generally configured to execute computer instructions to carry out certain tasks related to the providing online surveys to survey respondents. The processor 102 may be a standard personal computer processor such as those distributed by Intel, Advanced Micro Devices or Motorola. The processor 102 may also be a more specialized processor tailored for survey processes and programs. The system 100 may also include a memory 104. The memory 104 may include volatile memory 104A such as some form of random access memory. The volatile memory 104A may be configured to load executable software modules into memory so that the software modules may be executed by the processor 102 in a manner well known in the art. The software modules may be stored in a non-volatile memory 104. The non-volatile memory may take the form of a hard disk drive, a flash memory, a solid state hard drive or some other form of non-volatile memory.

The computer system 100 also may include a network interface 106. The network interface may take the form of a network interface card and its corresponding software drivers and/or firmware configured to provide the system 100 with access to a network (such as the Internet, for example). An operating system 108 is also included in the computer system 100. The operating system 108 may be a well-known general operating system such as Linux, Windows, or Mac OS X which is designed to provide a platform from which computer software applications may be executed by the processor 102. Alternatively, the operating system 108 may also be a special purpose operating system designed specifically for the online survey environment.

Running on the operating system 108 may be web server software 110. The web server software 110 may be a standard off the shelf web server product such as Apache, Internet Information Server, or some other web server software. Alternatively, the web server may form a part of the operating system 108, or it may be a specialized HTTP server which is configured specifically to deliver survey web pages to browsing software via a network such as the Internet, or some other local area network or wide area network. The web server software 110 may be stored in the memory 104 for access by the processor 102 to execute on the operating platform provided by the operating system 108. The computer system 100 also may include an application server 112. The application server 112 may take the form of specialized software designed to run applications within the system environment. The application server 112 may be integrated with the Web server 110 and/or the operating system 108. The computer system 100 further includes a survey module 114. The survey module 114 may include computer hardware and/or software which is configured to provide online survey applications which may run on the application server 112, on the web server 110, or both. The survey module generally is configured to allow for the creation and distribution of online surveys to survey respondents as will be discussed in additional detail below. In some embodiments, the survey module may include a web application such as a Flash-based application, and portions of the survey module 114 may be loaded into a web browser running on a remote computer.

Turning to FIG. 2, a more detailed view of the survey module 114 is provided. As shown, the survey module 114 may include configuration data 202. The configuration data 202 may take the form of an eXtensible Markup Language (“XML”) configuration file which includes data that may be used by the survey module 114 to create an online survey in accordance with one or more embodiments. The configuration file may include data which specifies the types of questions to be asked of survey respondents during an online survey. The configuration data may further include data indicative of more general themes with which the questions may be associated. For example, questions relating to a survey respondent's gender, age, and ethnicity may be associated with a “demographic” theme. Questions relating to a survey respondent's television viewing habits may be associated with a “television” theme. Question data may include both question text, and answer options. For example, a particular question may have a specific set of required answers from which a survey respondent may choose. These answers may also be included in the configuration data 202. In addition to specific questions, answers, and themes, the configuration data 202 may also include questions subjects. A particular survey may seek to ask respondents the same question about many different subjects. For example, a survey may be designed to ask respondents to rate several different companies on the same scale. Each of these companies may be considered a question subject.

The configuration data may further include instruction data which provides information to survey respondents on how a particular question should be answered. For example, for a question such as “What is the highest level of education you have completed?”, an instruction may be associated with the question which indicates to the survey respondent that only a single response among a plurality of choices should be selected. The configuration data 202 may further include graphics data which is associated with the questions. For example, icons which are indicative of a particular theme may be included in the configuration data. The configuration data 202, although typically stored as an XML file, may also be stored in various other forms. For example, the configuration data 202 may be stored in a relational database that is accessed by the application server 112.

Returning to FIG. 2, the survey module 112 may also include a question builder 204. Because online surveys include questions that are typically posed to survey respondents, a set of questions may be created from the configuration data 202 by the question builder 204. In some embodiments, the question builder 204 may be a top level class in an object-oriented software application. The question builder 204 may be configured to provide input and output of XML-formatted data which is stored in a database. In one particular embodiment, the question builder 204 may be configured to load the configuration data 202 and then provide the configuration data to a subject management module 206. The subject management module 206 may be a subclass of the question builder 204, and may generally be configured to group the various questions subjects so that they are efficiently displayed to survey respondents via the Web server 110. The question builder 204 may also include a question/response tree builder 208. The question/response tree builder 208 takes the configuration data 202 and builds survey logic designed to capture information from the survey respondents.

Turning now to FIG. 3A, an example of a traditional decision tree needed to model a question and response for a compound question is provided. In this particular example, an initial question is asked about a question subject. The question subject may take many forms. It can be a company, a product, a person, an idea, a concept, a place, a brand, or any other subject which is suitable for questioning in an online survey. Depending upon the answer received to the initial question about the question subject, additional follow-up questions are presented to the survey respondent. The decision tree includes the initial question 302. The initial question 302 is identified in the diagram as Q1, and it specifies a question subject 304. In this example, the question subject 304 is “Brand 1.” Thus, an initial question is asked about “Brand 1”. The initial question 302 specifies three possible answers 306A-306C which may be given by survey respondents. Here, the first answer 306A is “I use it.” When a survey recipient selects this answer, he indicates that he uses “Brand 1”. The second answer 306B to the initial question 302 is “I don't use it anymore.” When a survey recipient selects this answer, he indicates that he used “Brand 1” in the past, but no longer does so. The third answer 306C to the initial question 302 is “I've never used it.” Here, the survey recipient indicates that he has never used the brand which is the subject of the question.

Because the survey obtains limited information from the answer to the initial question 302, additional survey logic is needed to ask follow-up questions 308 from the survey respondents. These follow-up questions may be specific to the answers given to the initial question. For example a follow-up question to answer 306A may be different than a follow-up question given to answer 306B. Because there were three possible answers to the initial question 302, there are three different follow-up questions 308 which are defined. The first follow-up question 308A identified in the diagram as Q2a stems from the respondent's answer that he uses “Brand 1.” The first follow-up question 308A asks the survey respondent whether “Brand 1” is his preferred brand. Two possible answers are defined as shown in the decision tree. The first answer to follow-up question 308A is follow-up answer 308A1 “it's my preferred brand.” The second answer to follow up question 308A is follow-up answer 308A2 “it's not my preferred brand.”

The second follow-up question 308B, identified in the diagram as Q2b, stems from the respondent's answer that he no longer uses Brand 1. In this instance, the follow-up question asks whether the survey respondent would consider using the brand again, even though he does not use it anymore. Here the survey respondent is provided with two possible answers as well. The first possible answer is follow-up answer 308B1 “would consider using it.” The second possible answer is follow-up answer 308B2 “would consider it as a last alternative.” Thus, both the follow-up question and the answers to the follow up question are directly related to the initial answer given by the survey respondent.

The third follow-up question 308C, identified in the diagram as Q2c, stems from the respondent's answer that he has never used Brand 1. In this instance, the survey seeks to know whether, although the survey respondent has never used the brand, whether or not he would consider using. The survey respondent is provided with two possible responses to this third follow-up question as well. The first follow-up response 308C1 indicates that the survey respondent “would consider it.” The second follow-up response 308C2 indicates that the survey respondent “would never use it.” As with the previous two follow-up questions, this third follow-up question also is directly related to the initial answer given by the survey respondent.

Using the survey logic provided by the question/response tree builder 208, a user interface may be generated which efficiently conveys the questions to survey recipients and provides a simple and intuitive interface for receiving information from survey respondents. This user interface may be based on a streamlined decision tree, an example of which is provided in FIG. 3B. The streamlined decision tree uses the graphical presentation of data to simplify the survey logic needed to gather the same information as is gathered by the decision tree in FIG. 3A. In particular, the streamlined decision tree does not need to present the question, but instead merely presents a question subject 304 (in this case “Southwest Airlines”) and three possible responses 306A1, 306A2 and 306A3. As with the survey logic shown in FIG. 3A, follow-up responses presented to the survey respondent depend upon the answer provided by the survey respondent to the initial query. However, unlike the decision tree in FIG. 3A, the decision tree in FIG. 3B does not require the follow-up questions 308A-308C to be presented. Rather, the follow-up question responses 308A1, 308A2, 308B1, 308B2, 308C1, 308C2 are presented immediately adjacent to the initial responses, allowing the survey respondent to select the answer without needed to read a question.

FIGS. 4A-4G provide one example of the behavior and configuration of a graphical user interface which implements the survey logic set forth in FIG. 3B above. Turning to FIG. 4A, a user interface 400 is provided in which the survey logic from FIG. 3 is presented to a survey respondent so that the survey respondent may provide answers to the questions defined by the question/response tree builder 208. In this example, the first question 302 is asked about various brands 402. As shown these brands include various airlines. Rather than explicitly stating the initial question 302 (which, as described above, asks the survey respondent whether they use the brand), the user is simply presented with the three possible responses to find for the initial question 302. These answers may be presented as a row which follows each brand. Each specific answer may be listed in a specific column as shown. For example the first response 306A may be placed in a column 404. Similarly the second response 306B may be placed in a second column 406. The third response 306C is also placed in a separate column 408. Thus, the user is provided a simple interface for inputting their answer to the initial survey question.

Turning now to FIG. 4B, the user interface 400 is shown after the survey respondent has selected their initial response to the initial question for the Southwest brand. As shown the user has selected the response from the second column 406, “I don't use it anymore.” As a result of the selection, the background color of this response changes. This indicates to the user that the response has been selected. In addition, the survey respondent is immediately presented with the possible responses 308B1 (“but would consider using it”) and 308B2 (“but would consider as a last alternative”) to the follow-up question 308B associated with the answer 306B selected. In this embodiment shown, the possible responses 308B1 and 308B2 are presented as items 410 and 412 in a drop-down from the initial response selected by the survey respondent. These items are also available for selection by the survey respondent.

It should be noted that in some embodiments the survey respondent need not actually select the response in order for the drop-down to appear. In these embodiments simply moving the mouse over a particular response because the drop-down to appear and allow the user to know what the follow-up answers will be prior to making a selection of the primary answer. This type of implementation may also improve the speed with which the user may be able to complete the survey. It should be further noted that there is no need to actually recite or display the follow-up question to the survey respondent. For example, the user interface need not state “You indicated that you no longer use Southwest Airlines. Please indicate whether (a) you would consider using it or (b) you would only consider it as a last alternative.” Survey respondents often skip over text, these widgets obviates the need to display text likely to be unread anyway. Rather, the displayed response options provide the user the necessary context to understand what is being asked without the need for a detailed recitation of the follow up question.

In some embodiments, even if a selection of a primary answer has been made, the survey respondent may be required to make a secondary answer selection in order for the answer to be considered completed within the user interface 400. For example, if the user selects the primary response 306B from the second column 406, but fails to select one of the secondary responses, the user interface 400 may be configured to return that particular answer to its original state, and not reflect the selection of the primary answer. In other words, the user may be required to provide both the primary answer in the secondary answer in order for an answer to be recorded with respect to any given brand.

FIG. 4C shows the user interface 400 after the survey respondent has made a selection of a follow-up answer. In this instance, the survey respondent has selected the follow-up answer 308B1, shown as item 410 in the drop-down list adjacent to the selected primary answer. As shown, moving the mouse over the follow-up answer 308B 1 changes the color of the answer. This color change indicates to the survey respondent that actuating the mouse button on the computer, or otherwise providing a selection input, will result in the selection of this specific follow-up answer.

Turning now to FIG. 4D, the user interface 400 is shown after the survey respondent has selected the follow-up answer 308B1 for the Southwest brand, and made a selection of (or alternatively, moved the cursor of his mouse over) a primary answer for the next brand, shown in this example as Delta. As shown, in the role associated with the Southwest brand, the completed answer is expressed in column 406 by combining the two selected answers, the initial answer “I don't use it anymore,” and the selected follow-up answer 410 “but would consider using it.” As further shown, in the Delta row, the user has moved the mouse over, or selected (by clicking or tapping or other method), primary answer 306A (“I use it”), resulting in a drop-down menu having user interface elements 414 and 416, which reflect the secondary responses 308A1 and 308A2 associated with the primary answer 306A. Although this embodiment reveals the dropdown menu based on a mouse over action, a skilled artisan will readily appreciate that any number of other types of user input or selection, such as clicking, tapping, or the like, may be cause similar user interface behavior.

FIG. 4E shows the user interface 400 from FIG. 4D, with the mouse cursor having been moved by the survey respondent over user interface element 416, which reflects secondary response 308A2. Once the survey respondent makes the selection of user interface element 416 the answer to the primary and secondary questions pertaining to the Delta brand are also completed as shown in FIG. 4F. FIG. 4F also shows that the survey respondent has moved the mouse over column 408 in the row associated with American Airlines, which allows for the selection of the primary question answer 306C (“I've never used it”). Here, the user is presented with user interface elements 418 and 420, which reflect secondary responses 308C1 (“but would consider it”) and 308C2 (“and I would never use it”). As with the previous brands displayed to the survey respondent, selection of one of the answers to the secondary question results in the complete answer being consolidated into a single cell in the table.

FIG. 4G shows the user interface after the survey respondent has made a selection in connection with each and every one of the brands 402. As shown, in each of the rows, one of the columns is highlighted and includes both the primary answer and one of the secondary answers listed in this highlighted cell. With this type of configuration, the survey respondent can easily see each of the question responses, and can quickly review and modify those responses if necessary.

Although one specific example of a user interface is described above in connection with FIGS. 4A-4G, additional user interface designs may be used in accordance with the embodiments described herein. For example, a different user interface may be used in connection with a mobile device, or some other device in which screen size is limited. FIG. 4H provides an example of a user interface which may be used to provide similar functionality on a mobile phone design. As shown, the mobile user interface 430 may be organized to present the four possible responses (450, 454, 456, and 458) to the initial question. When the survey respondent selects one of the initial responses (in this case response 450), a menu of follow-up question responses 452 may then be presented for selection.

Turning now to FIG. 5, a flowchart showing one example of a process which may be used to generate the survey logic shown in FIG. 3 and the user interface 400 shown in FIG. 4. Typically, this process is performed by one or more persons involved with creating, generating, and implementing an online survey using a computer system such as computer system 100 equipped with a survey module 114 as shown in FIG. 1 and FIG. 2. The process begins at block 502, where the first question is defined. In some embodiments, the question may be defined simply by typing the question into a designated field in a user interface. Alternatively, the question may be defined by selecting the question from a set of questions which has been predefined and stored in a memory, such as memory 104 shown above in FIG. 1. Once the first question has been defined the process used to block 504, where answer options for the first question are defined. In the example shown in FIG. 3, the first question was defined with three answer options. However this is merely an example, and more or less than three answer options may be provided. As was the case with the definition of the first question, the answers may be inputted by the user, or alternatively may be predefined and selected from storage. Once the answer options the first question have been defined, the process then moves to block 506, where follow-up questions for each of the answer options defined in step 504 are created. As discussed above, these follow-up questions may be tailored specifically to the answer options with which they are associated, and they may also be predefined and/or inputted by the user.

Once the follow-up questions have been defined, the process moves to block 508 where answer options to the follow-up questions are also defined. In the example described in connection with FIGS. 3 and 4, each follow up question had two follow-up answer options associated with it. A skilled artisan will appreciate, however, that any number of follow-up answer options may be defined and associated with specific follow up questions. Once the questions, their respective answers, the follow-up questions, and their respective answers have each been defined, the process may then moves to block 510. There, question subjects may be defined and associated with previously defined questions and answer options. Depending upon the defined questions, the question subjects may be people, companies, brands, or some other entity. Typically, the question subjects defined in block 510 will have some sort of commonality which makes the defined questions and follow-up questions relevant to those subjects. Once the subjects have been defined, the process may move to optional block 512 where the groupings for the question subjects previously defined may be created. Allowing for the definition of subject groupings provides the ability to display similar question subjects adjacent to each other in the user interface accessed by the survey respondents. By grouping similar question subjects, the survey respondents are better able to compare and contrast the different subjects as the answer the questions and follow-up questions. This ability to compare and contrast the different question subjects may allow for the capture of more meaningful data regarding the question subjects. For example, the user interface 400 shown in FIG. 4 presents various airline brands together. Finally, after all of the questions, answer options, follow-up questions, follow up answers, subjects, and groupings have been defined, the process moves to block 514, where all of the survey data is stored in the system 100.

Once the survey has been defined and stored, the system 100 including the survey module 114 may be configured to generate a survey which may be presented to a survey respondent via a graphical user interface such as user interface 400. FIG. 6 provides an example of a process by which a survey may be generated, presented, and conducted in accordance with one or more embodiments of the invention.

The process begins at block 602, where the user interface is generated, including a separate row for each question subject along with its associated primary answer options. The user interface may be a user interface such as that described above in connection with FIG. 4, or alternatively it may take some other form. Once the user interface has been generated, the process moves to block 604 where the system 100 receives a selection of one of the primary answer options associated with one of the question subjects. In the example described in connection with FIG. 4, the first brand in the first row received the first inputted selection of an answer option. However, this need not always be the case, as a survey respondent may make a selection of another row initially, and then go back to earlier reference to complete the survey later. Moreover, a skilled artisan will appreciate that the selection may be an inputted mouse click, or it may merely be a mouse-over of the specific option. When the selection of one of the answer options is received, the process then moves to block 606 where the system highlights the selected option.

Next, the process moves to block 608 where the system generates secondary answer options for selection based on the first answer option selected by the survey respondent. Typically, secondary answer options may be generated by retrieving data from the question/response tree 208 associated with the survey. The data may be retrieved via a database query, or some other retrieval mechanism. Next the process moves to block 610, where the retrieved secondary options are displayed on the user interface, such as graphical user interface 400 for example, for selection by the survey respondent. The retrieved secondary options may be displayed proximate or adjacent to the highlighted first selected option. The secondary options may be presented to the survey respondent in a drop-down menu from the selected first option, as shown in FIG. 4. The secondary options may be presented in the user interface is a different configuration as well, such as in a radio box selection options, or some other selection configuration as known in the art.

Once the secondary answer options have been displayed to the user, the system awaits a user selection of one of the secondary answer options 612, where it is determined whether a selection has of one of the secondary answer options has been made by the user. If a selection has not yet been made, the process moves to block 614, where the user is prevented from making additional selections while the secondary question remains pending and answered. Preventing the user from moving onto a new question without first fully answering a secondary question helps to ensure that a complete data set is captured in the survey. If, the system determines at block 612 that a selection has been made, the process instead moves to block 616, were the completed response is displayed, including the first selection made by the user and the secondary selection. In some embodiments, the complete selection is displayed as shown in FIG. 4G, with both the primary answer and the secondary answer expressed as a compound sentence (“I don't use it any more, but would consider using it”). Moreover, in some embodiments, the portion of the user interface adjacent to or surrounding the answer may be modified to demonstrate that a completed answer has been given. For example, the background color surrounding the answer may be changed so that it clearly indicates that the answer has been provided. However, it should be appreciated that there as various ways in which the completed answer can be efficiently presented within the user interface so that the user can quickly and easily review their completed answers. Additionally, it is to be appreciated that the data gathered using the techniques described above may be collected and analyzed to generate reports which provide summary information regarding the responses made. These reports may take various forms and serve various purposes. As just one example, reports demonstrating brand equity may be derived from the answers to the compound questions presented.

Those of skill will recognize that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks modules, circuits, and steps have been described above generally in terms of their functionality. Whether such functionality is implemented as hardware or software depends upon the particular application and design constraints imposed on the overall system.

Skilled artisans may implement the described functionality in varying ways for each particular application, but such implementation decisions should not be interpreted as causing a departure from the scope of the present invention. The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CDROM, or any other form of storage medium known in the art. An exemplary storage medium is coupled to the processor such the processor can read information from and write information to, the storage medium. In the alternative, the storage medium may be integral to the processor.

The processor and the storage medium may reside in an ASIC. The ASIC may reside in a user terminal or some other type of device. In the alternative the processor and the storage medium may reside as discrete components in a user terminal.

What is claimed is:

1. A computer-implemented method of presenting and receiving compound answers to survey questions, the method comprising:
retrieving, from a computer memory, data indicative of a first question for which a user response is sought;
retrieving, from the computer memory, data indicative of a plurality of possible responses to the first question for which a user response is sought;
retrieving, from the computer memory, data indicative of a follow up question for each of the plurality of possible responses to the first question for which a user response is sought;
retrieving, from the computer memory, data indicative of a plurality of possible responses to each follow up question;
generating a user interface element for display on a user interface of a client device, the user interface element comprising at least a portion of a group of cells, the at least a portion of the group of cells comprising rows and columns, each row containing a cell indicative of a question subject and a plurality of cells arranged as columns indicative of possible responses to the first question about the question subject;
receiving data indicative of an inputted selection of a first response from one of the possible responses, the inputted selection being a selection of the cell associated with the selected first response;
based on the data indicative of the inputted selection of a first response from one of the possible responses, generating for display on the client device the plurality of possible follow-up responses to the follow-up question for the selected first response;
receiving, data indicative of an inputted selection of a follow-up response from one of the plurality of possible responses to the follow-up question; and
based on the data indicative of the inputted selection of follow-up response, generating instructions for modifying the cell associated with the selected first response on the client device,
wherein the modification of the cell provides an indication that the first question and the follow up question have been answered.

2. The computer-implemented method of claim 1, wherein the indication comprises a change in the appearance of the cell associated with the selected answer.

3. The computer-implemented method of claim 1, wherein the indication further comprises displaying both the selected first response and the selected follow-up response inside the cell associated with the selected first response.

4. The computer-implemented method of claim 1, further comprising after generating for display on the client device the plurality of possible follow-up responses to the follow-up question for the selected first response, generating instructions configured to require selection of one of the plurality of possible follow-up responses prior to any further input by on the client device.

5. The computer-implemented method of claim 1, wherein the question subject is presented as a brand identity.

6. The computer-implemented method of claim 1, wherein the first question can be inferred from the plurality of possible responses to the first question, and wherein the first question is not displayed on the user interface.

7. The computer-implemented method of claim 6, wherein the follow-up question can be inferred from the plurality of possible responses to the follow-up question, and wherein the follow-up question is not displayed on the user interface.

8. The computer-implemented method of claim 1, further comprising storing the inputted selections in data storage.

9. The computer-implemented method of claim 1, further comprising retrieving, from the computer memory, data indicative of a plurality of question subjects.

10. The computer-implemented method of claim 9, wherein the table includes the plurality of question subjects, and wherein the question subjects are each associated with a row in the table, and wherein the question subjects are grouped based on their relationship to each other.

11. An online survey system comprising:
data storage configured to store data indicative of a first question for which a user response is sought, a plurality of possible responses to the first question for which a user response is sought, data indicative of a follow up question for each of the plurality of possible responses to the first question for which a user response is sought, and data indicative of a plurality of possible responses to each follow up question;
a computing device in communication with the data storage and configured to:
generate a for display on a user interface of a client device a user interface element, the user interface element comprising at least a portion of a group of cells, the at least a portion of the group of cells comprising rows and columns, each row containing a cell indicative of a question subject and a plurality of cells arranged as columns indicative of possible responses to the first question about the question subject;
receive data indicative of an inputted selection of a first response from one of the possible responses, the inputted selection being a selection of the cell associated with the selected first response;
based on the data indicative of the inputted selection of a first response from one of the possible responses, generate for display on the client device the plurality of possible follow-up responses to the follow-up question for the selected first response;
receive data indicative of an inputted selection of a follow-up response from one of the plurality of possible responses to the follow-up question; and
based on the data indicative of the inputted selection of follow-up response, generate instructions configured to modify the cell associated with the selected first response on the client device,
wherein the modification of the cell provides an indication that the first question and the follow up question have been answered.

12. The online survey system of claim 11, wherein the indication comprises a change in the appearance of the cell associated with the selected answer.

13. The online survey system of claim 11, wherein the indication further comprises displaying both the selected first response and the selected follow-up response inside the cell associated with the selected first response.

14. The online survey system of claim 11, wherein the computer device is further configured to generate for display on the client device the plurality of possible follow-up responses to the follow-up question for the selected first response, wherein the instructions are further configured to require selection of one of the plurality of possible follow-up responses prior to any further input by on the client device.

15. The online survey system of claim 11, wherein the question subject is presented as a brand identity.

16. The online survey system of claim 11, wherein the first question can be inferred from the plurality of possible responses to the first question, and wherein the first question is not displayed on the user interface.

17. The online survey system of claim 16, wherein the follow-up question can be inferred from the plurality of possible responses to the follow-up question, and wherein the follow-up question is not displayed on the user interface.

18. The online survey system of claim 11, wherein the computing device is configured to store the inputted selections in the data storage.

19. The online survey system of claim 11, wherein the computing device is further configured to retrieve from data storage data indicative of a plurality of question subjects.

20. The computer-implemented method of claim 19, wherein the table includes the plurality of question subjects, and wherein the question subjects are each associated with a row in the table, and wherein the question subjects are grouped based on their relationship to each other.
